(19) United States
(12) Patent Application Publication
(10) Pub. No.: US 2008/0140512 A1
(43) Pub. Date: Jun. 12, 2008

(54) Website Contest and Method

(76) Inventor: Anthony K. Bruster, Texarkana, TX (US)

Correspondence Address: SLATER & MATSIL, L.L.P., 17950 PRESTON RD, SUITE 1000, DALLAS, TX, 75252-5793, US

(21) Appl. No.: 11/955,272

(22) Filed: Dec. 12, 2007

Related U.S. Application Data
(60) Provisional application No. 60/874,601, filed on Dec. 12, 2006.

(51) Int. Cl. G06Q 30/00; G06F 17/30

(52) U.S. Cl. 705/10; 705/14

(57) ABSTRACT

A method for conducting a contest over a network, the method that comprises displaying a plurality of spaces on a screen of a computer of a user, wherein the spaces are pre-designated for a contest answer that comprises a phrase, wherein the phrase comprises a plurality of letters, each letter corresponding to one of the spaces; revealing the letters in each space during a duration of the contest, the letters being revealed at time intervals during duration; receiving a user answer at a server computer, the contest answer being received from the computer of the user via a network; comparing the user answer with the contest to determine if the user answer is correct; determining a submission time of the user's contest answer; and determining whether the user answer is a winning answer based on the determination of whether the user answer was correct and the submission time.

This application claims the benefit of U.S. Provisional Application No. 60/874,601, filed on Dec. 12, 2006, entitled “Online Contest,” which application is hereby incorporated herein by reference.

### TECHNICAL FIELD

The present invention relates generally to conducting contests. In particular, the present invention relates to conducting contests via the Internet.

### BACKGROUND OF THE INVENTION

People are finding more and more entertainment via the Internet than ever before, including engaging in contests and games. A good number of working individuals also spend a good deal of time on the Internet during their workdays, at times browsing through Internet sites not related to their work. However, most users quickly browse pages they are familiar with for a specific purpose such as shopping, news, weather, and personal email. Advertisements are prolific on all these above-mentioned sites however, Internet users rarely pay attention to this constant bombardment of flashing advertisements. Businesses can avoiding wasting time and money on these stagnant promotional materials and increase the effect of their advertisements through new methods such as contests and games, especially contests requiring very short amounts of time allowing participants to engage in these contests throughout the workday without compromising their productivity and even at the same time engaging in mental stimulation that may help with work focus.

With the growing number of computer users connecting to the Internet, many companies are seeking the substantial advertising opportunities presented by this growing user base. Contests, promotions, and games are among the methods traditionally used by companies to attract potential consumers. In many cases, contests may be used to even teach or educate potential consumers about a business or its products. The rapid development of Internet advertising has generated a need for new methods of conducting contests.

Consumers are more likely to participate in online contests, promotions, and games if it is to their benefit, i.e. consumers reap some sort of reward like coupons, cash prizes, non-cash prizes and the like. Also, consumers are less likely to engage in these contests and contest-like systems if they feel that they must provide too much personal information or buy a product in order to qualify as a participant of these contests and contest-like systems.

This contest system allows advertisers to benefit from participant-consumers viewing the advertisements and even visiting company websites while at the same time avoiding the constant assault on these participant-consumers that drive the public away. What is needed in the Internet marketplace is a contest system that also promotes advertisements that engage consumers into participating.

### SUMMARY OF THE INVENTION

In accordance with one aspect of the present invention, a method for conducting a contest over a network, the method that comprises displaying a plurality of spaces on a screen of a computer of a user, wherein the spaces are pre-designated for a contest answer that comprises a phrase, wherein the phrase comprises a plurality of letters, each letter corresponding to one of the spaces; revealing the letters in each space during a duration of the contest, the letters being revealed at time intervals during duration; receiving a user answer at a server computer, the contest answer being received from the computer of the user via a network; comparing the user answer with the contest to determine if the user answer is correct; determining a submission time of the user's contest answer; and determining whether the user answer is a winning answer based on the determination of whether the user answer was correct and the submission time.

An advantageous feature of the embodiments of the present invention includes the improved appeal of Internet advertising.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a flowchart diagram of phrase progression;

FIGS. 2, 4, 6 and 7 illustrate flowchart diagrams of alternative embodiments of phrase progression;

FIG. 3 illustrates a contest submittal form;

FIG. 5 illustrates a contest page; and

FIG. 8 illustrates a registered user contest submittal form.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. Embodiments of the present invention are described herein in the context of a system, method, and apparatus. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

One illustrative embodiment of the contemplated invention is a system and method for operating a website that sponsors contests at fixed intervals for participants to have a chance to win prizes or money. Alternatively, the participants could win “points,” that could be redeemed for monetary or non-monetary prizes. In one embodiment, the user plays “just for fun,” without receiving anything in return for winning. The basic structure of the business and the website would work as described below.

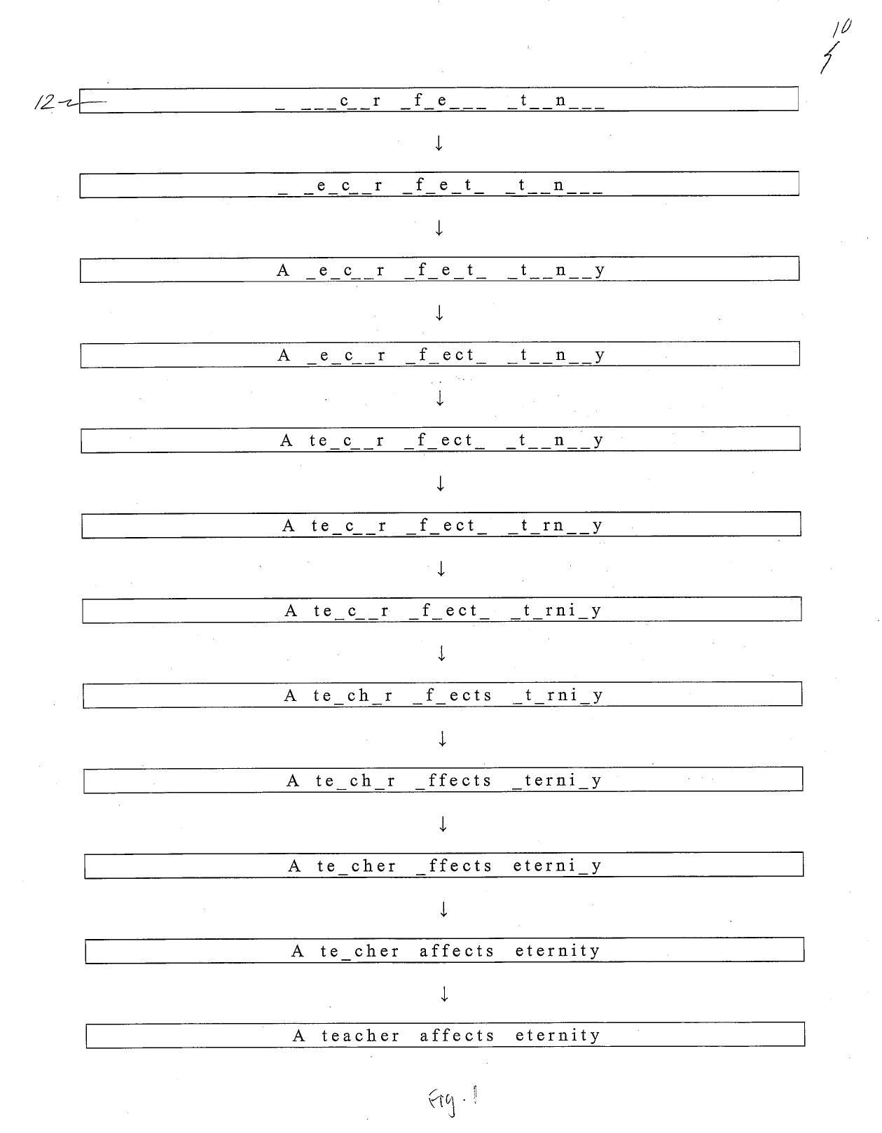

Reference is now made to FIG. 1, which is a flowchart illustrating contest process 10 as a preferred embodiment of the present invention. In this preferred embodiment, a “phrase of the day” 12 is released on the website at a certain time each day, for example, 11:00 am CST each day—this timing may allow for a greater United States' participation because it is 12:00 pm EST, 9:00 am PST, thus falling within the average workday hours for most people in the United States. Preferably, the contest could run multiple times during a day such as two or three times a day at fixed intervals, for example, as three separate contests beginning at 11:00 am CST, 4:00 pm CST, and 8:00 pm CST, to derive even more business throughout the day. Also, the contest could run daily, for example, seven days a week from Sunday through Saturday. However, since the goal is providing the best chance to reach as many people as possible while they are at their computers, the contest may also run from Monday through Friday, during the normal workweek. Preferably, the contest could alter the posting days or times in accordance with the demand of the public participants.

In accordance with a preferred embodiment of the present invention, phrase of the day 12 (also referred to as phrase 12) is a previously publicly released quote, either from, but not limited to, literature, movies/theater, sports, politics, television, history, and the like. It is preferable that the quote be from a publicly released medium (i.e., known or disseminated in the public domain), and its authorship be verifiable (and preferably verified by the contest operators, prior to release). Phrase 12 does not necessarily need to be somewhat unique, despite the proliferation of online quote dictionaries and the extensive reaches of Google and other forms of public internet search engines, and the like, because of the unique way in which phrase 12 will be released. In other embodiments, phrase 12 could be a headline or quote pulled from a periodical of wide distribution, such as The New York Times, Time Magazine, or the like. Such phrase 12 is more prone to being quickly identified by a key word search, but this is not problematic for the reason described below. Other phrases 12 including, e.g., famous names, scientific maxims, and the like, could also be employed. The phrase 12 could be as short as a single word or as long as a paragraph or more, e.g., an excerpt of a literature or poetry.

In a preferred embodiment of this invention, the phrase 12 may be released in a unique fashion, avoiding making the contest simply a “race to Google,” or any other form of search engine or other searchable means, in order to win. Preferably, at the set time for the contest to begin, only certain letters of phrase 12 are released as visible to the viewers of the website. Preferably the letters are spaced apart from each other so that no one word of phrase 12, with few exceptions with one-letter words such as “a,” is exposed upon this initial posting. For example, the non-visible letters are phased in at random intervals during a fixed period of time after the initial release of phrase 12, until all the letters in phrase 12 are visible to the viewer. In this context, the term “letter” includes numerals, apostrophes, hyphens and other characters or symbols that might be used in a phrase.

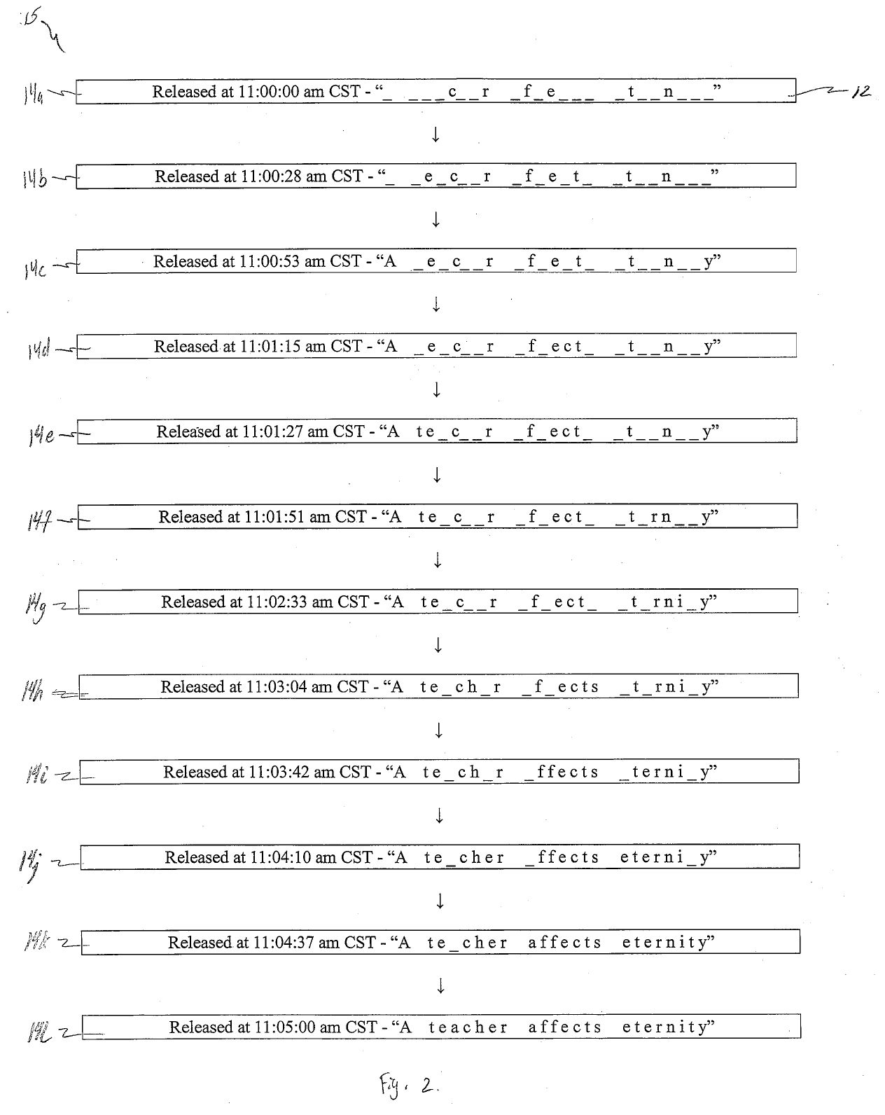

An exemplary feature of the invention includes a unique release feature of the letters of phrase 12. This preferable unique release feature allows for additional letters in phrase 12 to become visible to website viewers at random intervals (pre-selected by the contest operators, perhaps changing at random each day or week) during the fixed length of time that the specific contest runs. As an example, referring to FIG. 2, assume the following: (1) phrase 12 is “A Teacher Affects Eternity” by Henry Adams; (2) the contest starts at 11:00 am CST; and (3) the time period for the length of the contest is five minutes. At pre-set time intervals such as 28 seconds from initial release period 14a to period 14b, and 25 seconds between periods 14b and 14c, and so on through the contest, letters will be released until the final release period 141 that will signal the completion of the letter release for this contest, will all the letters of phrase 12 revealed.

In accordance with a preferred embodiment of the present invention, an initial release of phrase 12 begins the contest. Once phrase 12 is released, participants compete to submit the correct quote and its original author or speaker. The submission process will be discussed later. The winner must be (1) accurate in both the submission of phrase 12 correctly and the author or speaker of the quote, and (2) the first to submit both these correct answers. The contest operator will verify the submitted answers and the winner wins the prize for that contest—for example, $1,000 or non-monetary forms of winnings. In the case of multiple correct entries, the time factor of the first submitted answer actually received by the contest operator controls and the participant submitting this set of correct answers wins. In the case where there are multiple authors/speakers of phrase 12, the first set of correct answers that is submitted with the earliest correct author/speaker wins—even if that contestant was not actually the first to submit the proper phrase 12. In order to win, both segments of the answer set must be correct, phrase 12 and the author/speaker. In other embodiments, first publicized date, first public source, or the like can be integrated as part of the answer rather than just the two-part answer illustrated in this example.

Referring still to FIG. 2, in an illustrative embodiment of the present invention, phrase 12 is released on the website at a certain time each day, for example in this illustration of time-release process 15 beginning at 11:00 am CST at period 14a. At pre-selected time intervals or random time intervals, additional letters in phrase 12 become available to the user. In a preferred embodiment of this present invention, the time release of phrase 12 may range from a short amount of time, such as five minutes as illustrated in this example, to longer periods of time, such as thirty minutes or longer for example. Preferably, this fixed time window allows phrase 12 to evolve from a cryptic collection of letters into a famous quote. As illustrated in FIG. 2, the total time period of the contest in this exemplary embodiment consists of five minutes. In this example, users have five minutes to solve phrase 12 and be the first to submit the answer with the correct author or speaker. Although the revealing of phrase 12 may be completed, participants may continue submitting answers for a pre-determined amount of time, for example, until the next contest begins, thirty minutes after phrase 12 is fully revealed, or the like.

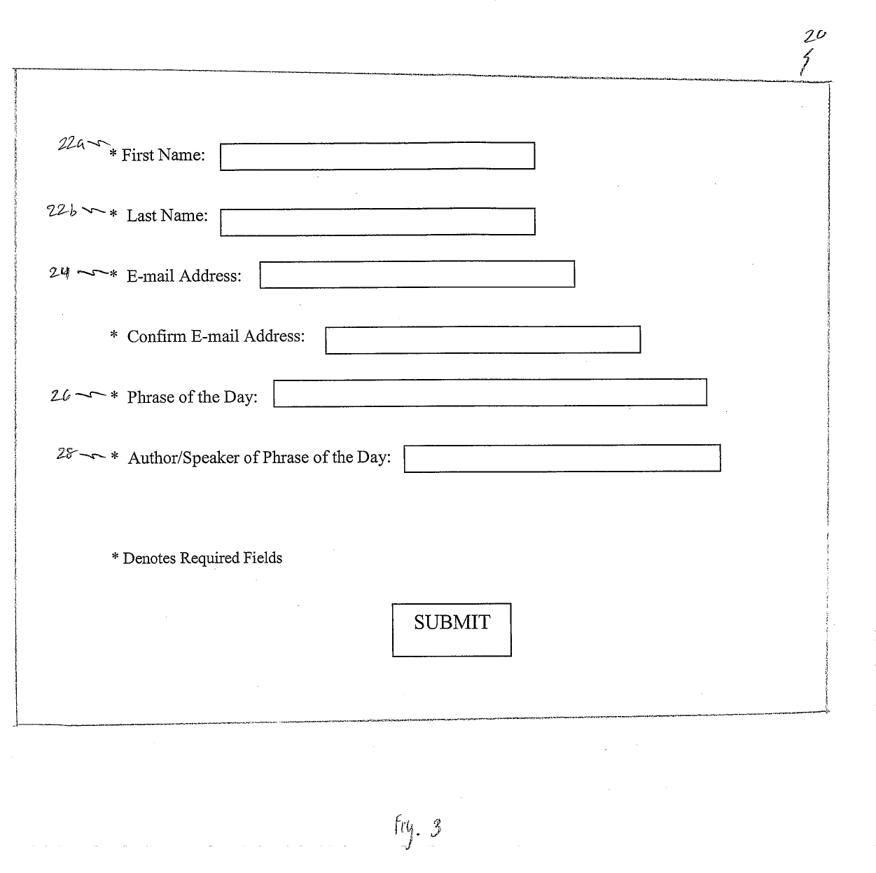

In accordance with a preferred embodiment of the present invention, in order to win the contest, the website viewer simply needs to guess phrase 12 correctly and attribute it to the proper author or speaker and be the first person to submit these correct answers. In an embodiment of the present invention, the website user may submit his entry by several forms, including but not limited to, a page with preset fields for text entries, a dedicated phrase 12 entry field that limits the letters and spaces entered to the actual correct answer, and other forms. Referring to FIG. 3, preferably, users may make their entries on blank form 20 existing on the website itself with at least the following required fields for the viewer to complete: (1) first name 22a; (2) last name 22b; (3) email address 24; (4) phrase of the day 12; and (5) author/speaker of the phrase of the day 28. Upon completing these fields, the website user may submit his entry directly to the website host.

In other embodiments, the contest could run over the course of a longer period of time with an appropriate delay between release periods of additional clues. For instance, a new clue could be provided each successive day at 11:00 am CST. In yet other embodiments, participants can affect the timing of the release of additional clues, as discussed below.

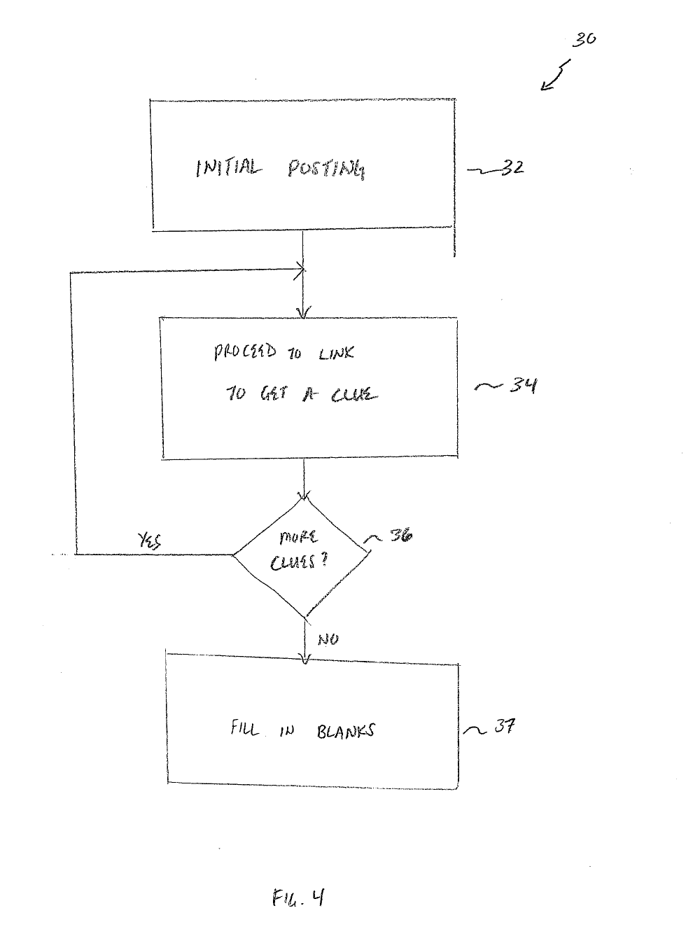

FIG. 4 illustrates a flowchart of link release process 30 that may be illustrative of a preferred embodiment of the present invention wherein a user could obtain a new, and quickened, release of a clue by, including but not limited to, navigating to another Web page or resource. The system can track this navigation with the appropriate cookies, from which the original page be caused to release another clue. The link may be provided for within the initial contest phrase 12 release site.

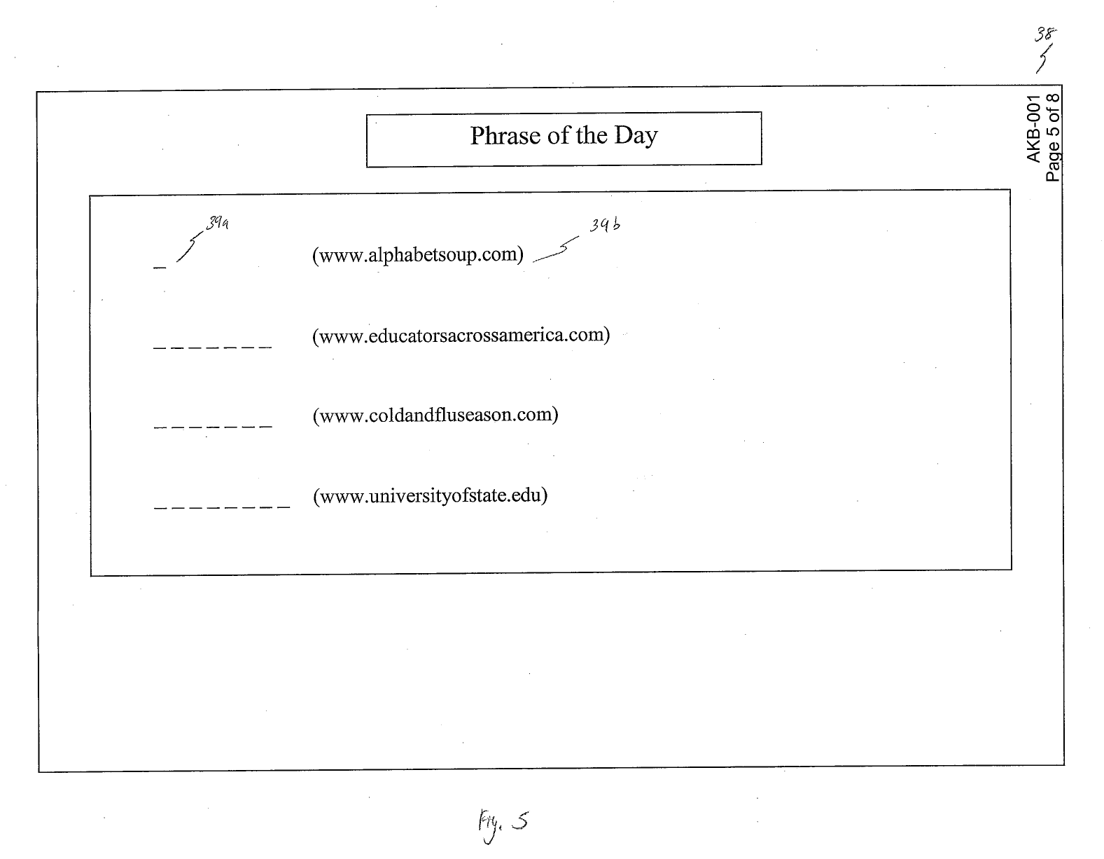

As illustrated in FIG. 4, users may click on links provided by phrase 12 release site and be required to garner clues that aid users in filling in certain blanks of phrase 12. Step 32 illustrates the initial release of phrase 12. Step 34 follows step 32, wherein a user may select a link provided by the release site and solve for particulars in phrase 12, such as but not limited to, gathering clues from the secondary site, finding the actual word for phrase 12 from the secondary site, or following through with some sort of online polling that may release a word for phrase 12. This is illustrated in FIG. 5 with contest page 38. Contest page 38 illustrates contest word 39a coinciding with hint link 39b. A user may click on hint link 39b and find either clues or even a direct answer to determine contest word 39a. Users may repeat step 34 as many times as may be necessary as shown in step 36 wherein the users may proceed to link N, wherein N is an integer greater than one. From the information garnered from step 34, users would fill in phrase 12 blanks as appropriately as shown in step 37.

For example, a participant may click on a link (located next to the blanks for the word “Teacher” in the exemplary phrase 12 in use in this example) such as celebratethisdate.com. The participant clicks on this provided link and is redirected to this page that announces the particular day is “Teacher Appreciation Day.” The participant may then find the word “teacher” and fill in the appropriate blanks for phrase 12. Also, alternatively, there could be a small icon on the redirected pages that denotes the location of the contest phrase 12 clue, such as a dollar sign, star, or the like. This may make it simpler for the participants to locate the necessary clues while browsing through the website.

In one embodiment, the user is directed to a different website. In another embodiment, the user's display can be segmented into a plurality of frames. For example, a frame along the top of the screen can show the contest phrase blanks while the remainder of the screen is used to redirect the user to various additional sites as described herein.

Alternatively, the participant could affect the release of an additional clue(s) by providing information, participating in an on-line poll, or the like. This approach could occur in lieu of periodic releases, or in conjunction with periodic releases.

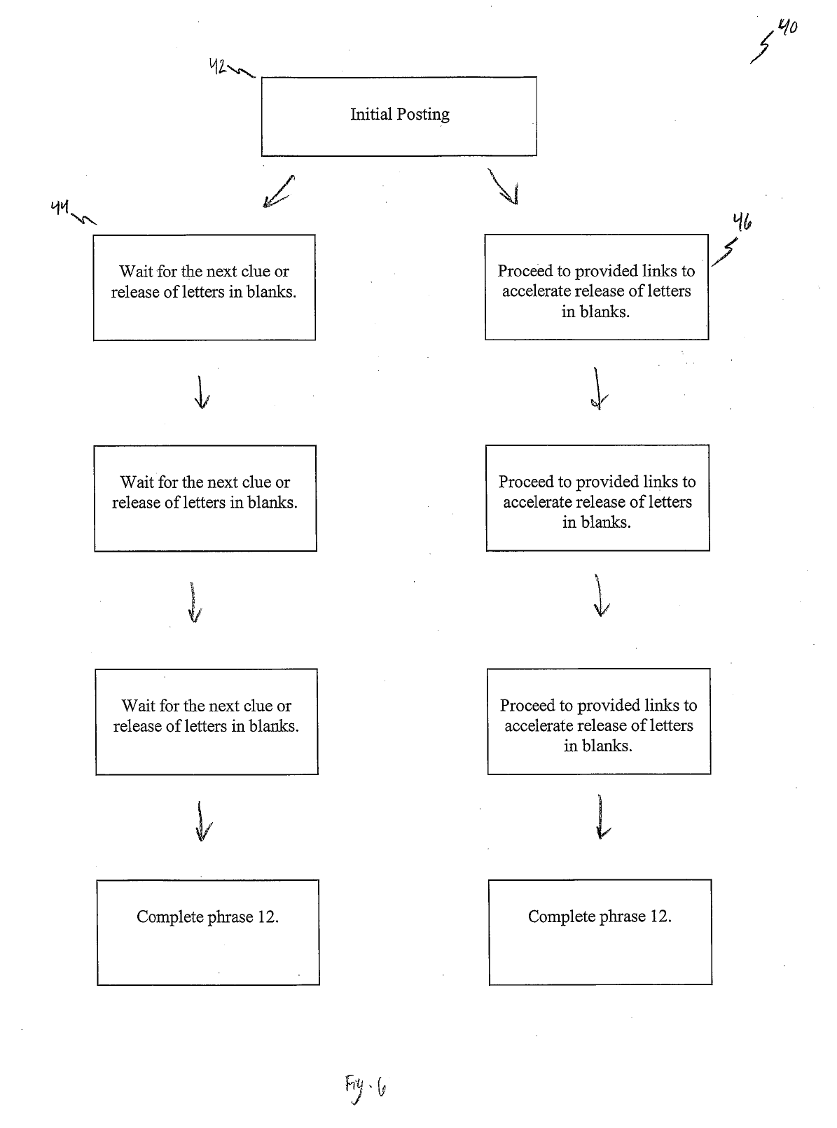

FIG. 6 illustrates another alternative approach in flowchart 40. In accordance with this preferred embodiment, initial posting 42 of phrase 12 is released and users may choose either to wait for the periodic letter release as shown in step 44. Users may also choose to accelerate the release of letters in the blanks to phrase 12 as shown in step 46 by engaging in steps 34 and 36 as shown in FIG. 4.

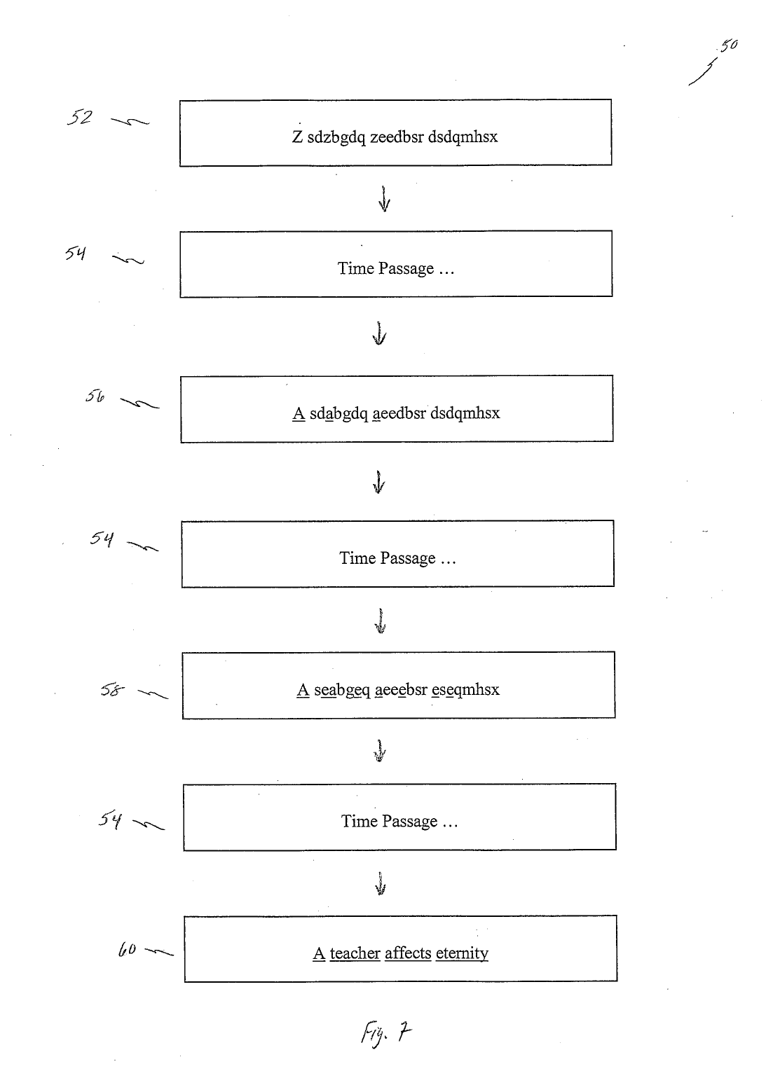

In accordance with other approaches for preferred embodiments of the present invention, phrase 12 may be encrypted. For instance, in one embodiment, phrase 12 could be encrypted using an approach in which each letter in phrase 12 is substituted for by some other letter or symbol. As a simple example, the above-discussed phrase 12 could be encrypted by substituting for each letter with the immediately preceding letter of the alphabet. This exemplary feature of a preferred embodiment of the present invention is shown in FIG. 7. In this figure, the first released phrase 12 is encrypted phrase 52. One or more letters in encrypted phrase 52 could then be “solved” by substituting the correct letter for the substituted letter at regular periods as shown in time interval step 56, such as the five-minute intervals. Those letters that are “solved” could be indicated by appropriate use of different fonts, colors, underlining, or the like. For instance in step 56, after time interval step 54, five minutes for example, phrase 12 could be updated to solve for one letter, as follows, where the “solved” letter is indicated by underlining. Numerous other encryption and substitution approaches are within the contemplated scope of the invention. As time passes, as illustrated with time passage 54, more letters are unencrypted, as illustrated through steps 56 and 58, eventually resulting in a fully unencrypted version of phrase 12, as illustrated in step 60.

In yet another contemplated embodiment, “clues” to phrase 12 could be embedded in the Web sites of sponsoring companies. For instance, rather than displaying phrase 12 in an encrypted fashion, various hyper-links, or URL's of other Web pages or Internet resources could be displayed. Users would need to navigate to and through those pages or resources and discover therein the “clues” to solving the phrase. As one example in a preferred embodiment, the original page might direct participants to navigate to a target page and identify therein the Xth word or Xth letter (where X is any desired number). Preferably, each such clue would identify one word or one letter in phrase 12 to be solved. Clues to each successive word or letter could then be added at periodic intervals. Also, in accordance with another embodiment, the contest could be configured such that users would need to “glean” phrase 12 by “deciphering” the overall message or context of the various Web pages to which the users are directed. To continue with the example phrase, “A Teacher Affects Eternity,” clues could be provided by directing users to, e.g., a Web page dealing with teaching, followed by a Web page that may evoke the word “affects” (perhaps a dictionary listing for that word), followed by a Web page dealing with the concept of time or eternity. Numerous variations will be apparent to those skilled in the art with the benefit of the present teachings. While this embodiment results in users navigating away from the original page, it may provide the advantageous feature of increasing traffic to a sponsor's Web page or resource.

After the contest closes, which occurs at a fixed time after all letters of phrase 12 have been released, or all the “clues” have been released, the entries are reviewed (either manually, or preferably automatically by a customized computer software program) to find which entry first submitted the correct phrase 12 and attributed it to the earliest correct author/speaker. That user would be the winner of that contest. The winner could be announced in any number of ways. One way this could occur, in order to drive more traffic to the website, would be to announce, at the close of each contest or even a window of time later in the day during which the winner would be announced. Continuing with the example as described above, if phrase 12 was fully released by 11:05 am CST, the contest might remain open until 11:25 am CST for users to submit entries. At 11:25 am CST, the website would display an announcement that the contest is now closed, and that the winner will be announced between 3:00 pm CST and 3:30 pm CST. The intervening time would be spent analyzing the entries and verifying the winning entry, and between 3:00 pm CST and 3:30 pm CST, the winning entry is announced. This exemplary process may drive more traffic to the website as users check to see if they won the prize, whether it be cash, points, rewards, or the like. As described earlier, this process, start to finish, could be replicated several times daily to maximize website traffic.

In accordance with a preferred embodiment of the present invention, the winners of the contests are awarded with prizes. Preferably, the amount awarded to the winner of each contest may be constant or may vary. Alternatively, the prize amount, if numerative such as in the form of accumulating points that may be applied to acquiring listed prizes, or cash, or the prize amount may increase if no user wins the contest. For example, if the initial prize award is $50.00 USD for the first contest of the day, and no one wins this contest, the $50.00 would be rolled over into the next prize amount in the next contest. The website host can confirm the identity of each contest winner and arrange for payment any number of ways, include by email, telephone, physical mail, electronically, or otherwise. Other variations could be employed in an effort to increase website traffic; as an example, each winner could be required to pass along an email to three friends describing the winner's success in the contest and encouraging those friends to play the next contest, as a condition before the winner is awarded the prize. Also, a condition could be placed on the winning entrant to respond and “claim” their prize, and if they do not respond within a predetermined window of time, the next correct contestant may be declared the winner at a certain time, possibly driving further traffic to the site.

Also, many variations of the contest format can spring out of this original platform. As one variation, the website could host some sort of “champions” round at any given interval. For example, the last week of the June and the last week of December, a private tournament may be held that is open only to people who have won any one contest during the preceding six months. Those winners could be verified by a log in process or some other procedure that makes the contest open only to this limited pool of players. Any number of formats could be used to score the contests during this week; for example, since there are only a limited number of entrants, each contest could rank all the submissions and assign a point value for each person's “place” in submitting their correct answer. At the end of the “champions” round, the player with the highest ranking from that week's contests wins a significantly larger sum of money—for example, $25,000. The opportunity to be in this “champions” round at the end of each half-year could be marketed along with the overall marketing push for the daily contests, so that the much larger contest sum could be made visible and used as an enticement to draw in more players each day.

In another preferred embodiment of the present invention, the website could also host an expanded platform on top of the original concept, and create an online forum where individuals may go to challenge others during the time period that the contests are not being administered, or a form of an online casino, and other like contests and tournaments. For example, there could be separate forums deriving from the main site that are separated by category, such as sports, movies and plays, history, politics, etc. Each of these forums could have running contests sponsored by the site itself, or have contestant-driven challenges in an open format, where anyone could try and knock off other people in the forum by challenging them to name quotes that they offer, or answer other trivia questions, and the like. As an example of the various types of formats, there could be a “name that movie” challenge, wherein a pool of contestants signs up to participate. They would play against others in the forum, either by speed or by turn. In this example, the quote “show me the money” is presented and Player 1 has 5 seconds to name the first movie that popularized that quote. If he cannot do so, Player 2 has a chance; if Player 2 is successful, Player 1 is eliminated, and Player 2 will proceed on to meet the winner of Player 3 and Player 4. Also in accordance with a preferred embodiment of the present invention, players could be seeded just like a sports tournament, and the winner at the end of this contest wins a prize offered by the site. These types of contests could be administered in many various formats to increase site traffic during the down times that the phrase of the day contest is not occurring.

In accordance with a preferred embodiment of the present invention, the original “phrase of the day” contest could also be transmitted in a number of mediums to reach as many players as possible. For example, iPod™ podcasts could be coordinated with the website to release the phrase of the day to persons viewing the contest on their iPod™. A special “mobile” version of the contest could be employed for persons participating by BlackBerry™, mobile phone/handheld computer, and the like. Preferably, a person would customize his viewing of the site in any number of ways. Also, another exemplary feature of a preferred embodiment of the present invention includes a membership function on the site wherein users could register with the site and obtain a username and a password that would provide these registered users with certain site benefits including early notifications of things relating to the site before the information is released to the general public such as increases in prize amounts, or even hints to contest answers, discounts with sponsors of the site, and the like.

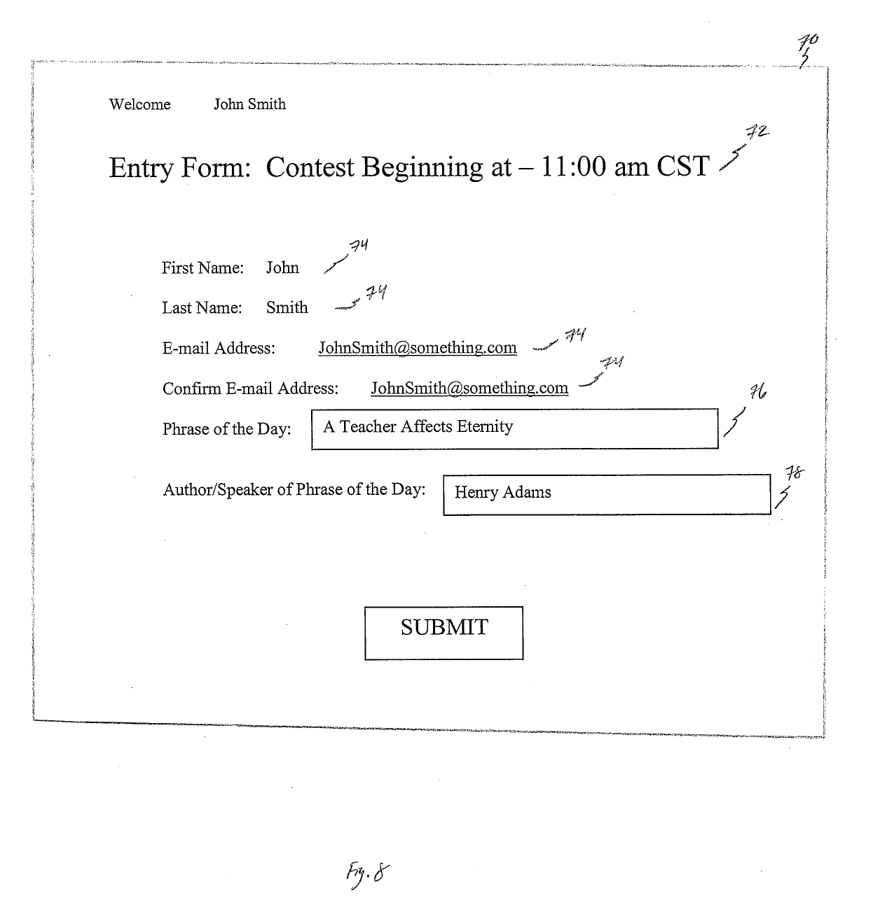

An exemplary feature of the membership function includes the ability for a registered user to submit their answers to contests in a quicker fashion than unregistered users as illustrated in FIG. 8. For example, a registered user, exemplary user John Smith in this example, could log into the site before the first contest of the day and navigate through the site to preset answer sheet 70 for the contest 72 John Smith is interested in. Thus, when John Smith deciphers the answer, he does not need to fill out the other requisite sections 74 of a submission form as other unregistered users. Rather, John Smith as a registered user, may just type in phrase of the day answer 76 and author/speaker answer 78 and click “submit” in order to send in their answer to the site. This may save the registered user valuable time in submitting answers as an embodiment of the present invention describes a time-sensitive contest in which the first user to submit the correct answer wins.

Other benefits of this membership function include, but are not limited to, the ability to play in one of the site's trivia forums, or even allow registered users a two-second head start or “advance viewing” of each letter as it appears while the phrase is being released. Such a method could be employed to encourage repeat participants or contestant loyalty, and to update “repeat customers” by email of new contestants, special offers, etc.

An advantageous feature of the preferred embodiments of the present invention includes contributing to people staying in a particular website for longer periods of time than an average website visit, and enhancing the website as an advertising medium for both consumers and advertisers.

Although the present invention and its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for conducting a contest over a network, the method comprising:
displaying a plurality of spaces on a screen of a computer of a user, wherein the spaces are pre-designated for a contest answer that comprises a phrase, wherein the phrase comprises a plurality of letters, each letter corresponding to one of the spaces;
revealing the letters in each space during a duration of the contest, the letters being revealed at time intervals during duration;
receiving a user answer at a server computer, the contest answer being received from the computer of the user via a network;
comparing the user answer with the contest to determine if the user answer is correct;
determining a submission time of the user's contest answer; and
determining whether the user answer is a winning answer based on the determination of whether the user answer was correct and the submission time.

2. The method according to claim 1, wherein displaying a plurality of spaces comprises displaying letters in each space.

3. The method according to claim 2, wherein the letters displayed in each space can be decoded as actual letters of the contest answer.

4. The method according to claim 2, wherein the letters displayed are not encoded for actual letters of the contest answer.

5. The method according to claim 1, wherein the contest answer comprises the phrase and at least one other piece of information, the other piece of information comprising a first publicized date, a first public source, an earliest author, and/or an earliest speaker of the phrase.

6. The method according to claim 1, wherein revealing the letters comprises revealing letters in response to the user performing a predefined selected action.

7. The method according to claim 6, wherein the predefined selected action comprises submitting information to a poll or a survey.

8. The method according to claim 6, wherein the predefined selected action comprises clicking on a provided link.

9. The method according to claim 8, wherein clicking on the provided link redirects the user to a webpage.

10. The method according to claim 9, wherein the webpage provides a hint to a letter or a word of the contest answer.

11. The method according to claim 1, further comprising providing an answer form at the user computer, wherein receiving the user answer comprises receiving a user answer in the form of the answer form.

12. The method according to claim 1, wherein the phrase comprises a plurality of words.

13. The method according to claim 12, wherein the phrase comprises a sentence.

14. The method of claim 1, wherein the network comprises the Internet.
